(19) United States
(12) Patent Application Publication
(10) Pub. No.: US 2006/0164796 A1
(43) Pub. Date: Jul. 27, 2006

(54) Electronic component for radio frequency applications and method for producing the same

(76) Inventor: Horst Theuss, Wenzenbach (DE)

Correspondence Address: EDELL, SHAPIRO & FINNAN, LLC, 1901 RESEARCH BLVD., SUITE 400, ROCKVILLE, MD, 20850, US

(21) Appl. No.: 11/337,792

(22) Filed: Jan. 24, 2006

(30) Foreign Application Priority Data
Jan. 24, 2005 (DE) 102005003298.2-33

(51) Int. Cl. H02B 1/00

(52) U.S. Cl. 361/600

(57) ABSTRACT

An electronic component for radio frequency applications is surrounded by a housing for protection, wherein the housing is produced from a foamed material.

### CROSS REFERENCE TO RELATED APPLICATIONS

This application claims priority under 35 USC §119 to German Application No. DE 10 2005 003 298.2, filed on Jan. 24, 2005, and titled “Electronic Component for Radio Frequency Applications and Method for Producing an Electronic Component for Radio Frequency Applications,” the entire contents of which are hereby incorporated by reference.

### FIELD OF THE INVENTION

The present invention relates to an electronic component for radio frequency applications and to a method for producing such an electronic component for radio frequency applications.

### SUMMARY

In electronic components that are exposed to radio frequency, the materials in the direct vicinity of the interconnects, for example materials that are used for housings of semiconductor elements, significantly influence the electrical capabilities of the component. Specifically, the processability and integrity of high frequencies decisively depend on the following two factors or variables: the dielectric constant and the loss factor. The dielectric constant ε influences the signal propagation speed by the relationship propagation speed ˜1/ε^{1/2}. It is generally desirable to obtain low values for ε, in order to achieve high speeds and thereby avoids delays. The impedances increase approximately linearly with ε. The loss factor tan δ determines the dispersion (distortion) of a signal. A low loss factor prevents a signal from dispersing. For example, with a small tan δ, a squarewave pulse retains its form virtually undistorted during the transit time over a certain distance.

It is currently customary in housing technology to use partially filled plastics, generally thermosetting plastics, less commonly also thermoplastics, with typical values of ε≈3-5 and tan δ≈0.01, these values being temperature-dependent and frequency-dependent and the values indicated relating to about 1 GHz. The materials serve as materials for housings intended for protecting circuits and for ensuring reliability.

The aforementioned material properties ε and tan δ limit the suitability for use of customary housing technologies to specific radio frequency applications. Depending on the application, the capabilities of the respective components are restricted or impaired as from a specific fundamental frequency.

Heretofore, housing materials that have “downwardly optimized” material properties with respect to ε and tan δ, have been used in the art, the aforementioned values however already characterizing materials that are quite good.

A further alternative in housing technology is to use hollow housings in which, for example, wire connections (so-called wire bonds) are enclosed not by plastic but only by air with a value for ε≈1. However, a serious disadvantage of this alternative is the resultant unreliability of the components.

Another approach to solving this problem is that of design optimizations, for example minimization of the conductor paths or wire bonds or short interconnects by flip chip variants. This solution also is not optimal, and a further advantage or a further improvement could of course also be achieved in such designs by using better material properties with respect to ε and tan δ.

### SUMMARY

The present invention provides an electronic component for radio frequency applications and a method for producing such an electronic component, wherein the housing material of the electronic component does not influence or significantly influence the processability and integrity of high frequencies. In particular, an electronic component for radio frequency applications is surrounded by a housing for the protection of the circuits, for example, the housing being produced from a foamed material. Foamed materials or foams of polymeric materials are formed by the release of dissolved blowing agents or by gases evolving during crosslinking reactions. The cellular structure formed in this way naturally has a high gas content. Consequently, the effective dielectric constant falls to values close to the theoretically achievable value of 1. A clear improvement of the material properties in comparison with conventional materials or of the housings produced from them occurs. The use according to the invention of foamed material for the housing allows outstanding radio frequency conditions to be achieved. Furthermore, this additionally brings about a significant reduction in the weight of the electronic component, which is likewise desirable.

According to a preferred embodiment of the invention, the foamed material is a plastics material.

According to another preferred embodiment of the invention, the foamed material may also be an elastomer.

The electronic component is preferably a discrete element. According to a further embodiment, the electronic component has a semiconductor component.

It is particularly preferred if the foamed material is produced from a thermoplastic material, since virtually all thermoplastics can in principle undergo foaming.

In yet another embodiment, the foamed material is a rigid or rigid-elastic foam, in particular based on polystyrene (PS), polyurethane (PU) or polyvinyl chloride (PVC). Rigid-elastic foams have a great deformation resistance and can therefore be of advantage for specific applications. For example, rigid PVC foam is a fully closed-cell foam that can be produced in densities from 30 to 80 kg/m³ and rigid polystyrene foam can be produced for example by the extrusion method in densities from 30 to 120 kg/m³ or by the slabstock foaming method from 10 to 40 kg/m³.

Another preferred embodiment provides as the foamed material a soft or soft-elastic foam with low deformation resistance, in particular based on polyurethane (PU), polyvinyl chloride (PVC) or polyethylene (PE).

It is particularly preferred if the foamed material contains particles of other substances, in particular metallic particles, to increase or improve the thermal conductivity and thermal capacity. It is also possible in this way to create a shielding action by a skin effect.

According to the invention, a method for producing an electronic component for radio frequency applications includes producing a housing which surrounds the electronic component for protection comprising a foaming process for the foaming of a material. The method according to the invention allows the production of an electronic component which has a housing that is significantly improved with respect to the material properties ε and tan δ, by contrast with conventional housings, whereby in turn outstanding radio frequency conditions are achieved.

A plastics material, in particular a thermoplastic material, is preferably foamed in the foaming process in the method.

According to a further preferred exemplary embodiment, a rigid or rigid-elastic foam with a high deformation resistance, in particular based on polystyrene (PS), polyurethane (PU) or polyvinyl chloride (PVC), is used in the foaming process.

In another preferred exemplary embodiment, a soft or soft-elastic foam with a low deformation resistance, in particular based on polyurethane (PU), polyvinyl chloride (PVC) or polyethylene (PE), is used in the foaming process.

The optional use of rigid foam or soft foam allows the mechanical properties of the housing to be adaptable.

A semiconductor component with a semiconductor housing of foamed plastics material is preferably produced.

It is particularly preferred for the method to be used for encapsulating semiconductor chips or semiconductor modules, for example for encapsulation after the processes of die/wire bonding on substrates.

In a further exemplary embodiment, the housing is produced by a spraying method, by an injection-molding method or by extrusion.

It is particularly preferred if particles of another substance, in particular metallic particles, are added to the foamed material in order to increase the thermal conductivity and thermal capacity.

The above and still further objects, features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

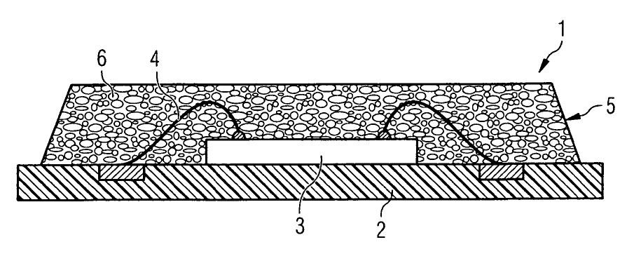

The invention is described in more detail with reference to the drawing, in which FIG. 1 shows a schematic cross section through an electronic component with a foamed-on housing.

### DETAILED DESCRIPTION

FIG. 1 shows a schematic cross section through an electronic component 1, here a semiconductor component. The semiconductor component has a carrier 2, on which a semiconductor chip 3 is applied. The semiconductor chip 3 is bonded to the carrier 2 by leads 4. The semiconductor chip 3 is surrounded or encapsulated by a housing 5 for protection. The housing 5 is formed from a foamed material 6, here from rigid polyurethane (PU) foam. The rigid PU foam is a predominantly closed-cell, hard and tough foam. For example, a rigid PU foam that is resistant to high temperatures and sold under the name Eccostock® may be used here. This rigid foam can be used in a temperature range from −70° C. to +135° C. and has a typical thermal conductivity of around 0.03 watt·m⁻¹·K⁻¹. Furthermore, Eccostock® has an extremely low dielectric constant.

The typical properties of this polyurethane are listed in the following table.

| | Apparent density (g/cm³) | | |
|---|---|---|---|
| | 0.03 | 0.13 | 0.22 |
| Dielectric constant (10⁴ to 10¹⁰ Hz) | 1.04 | 1.12 | 1.25 |
| Loss factor (10¹⁰ Hz) | 0.001 | 0.002 | 0.005 |
| Dielectric strength (kv/mm) | 1.58 | 1.58 | 1.58 |
| Compressive strength (kg/cm²) | 2.1 | 17.6 | 42.3 |
| Flexural strength (kg/cm²) | 1.8 | 15.8 | 56.0 |
| Modulus of elasticity (kg/cm²) | 35.2 | 493 | 1408 |
| Tensile strength (kg/cm²) | 2.8 | 14.1 | 31.7 |
| Shear strength (kg/cm²) | 2.5 | 9.9 | 21.1 |
| Coefficient of thermal expansion | 25 × 10⁻⁶ | 40 × 10⁻⁶ | 50 × 10⁻⁶ |
| (per ° C.) | | | |
| Water absorption, % per grain in | 3 | 1.5 | 1 |
| 24 hours | | | |

Further standard materials that can be used for producing the housing 5 of the electronic component 1 or semiconductor component according to the invention are, inter alia, KMC 180-7 or UK-KAA-C/97 ShA. UK-KAA-C/97 ShA is a polyurethane elastomer and, as a rubber-elastic chemical material, brings together particularly favorable combinations of physical and chemical properties and is a particularly high-performance material.

However, the main changes of the material properties with respect to ε and tan δ can be achieved with any other foamed thermoplastic, the changes of the electrical properties during the transition from the solid material to the foamed material being represented in the following table. The values indicated relate in this case to the low GHz range.

| | Currently customary housing | |
|---|---|---|
| | material (thermoset) | Foamed material |
| ε | 3-5 | <1.3 |
| Dielectric | | |
| constant | | |
| tanδ | about 0.01 | about 0.001 |
| Loss factor | | |

There follows a description of the foaming method. Foams of polymeric materials are formed by blowing agents dissolved in the plastic or gases evolving during the crosslinking reaction being released. In the case of thermoplastics, the foaming process is initiated by heating. This involves the evaporation of relatively low-boiling substances such as monomers or solvents that are incorporated in the molding compounds or the disintegration of mechanically admixed blowing agents, with gas evolving. As already mentioned, virtually all thermoplastics can be processed by such methods to form rigid or soft-elastic foams. Permanent gases, usually nitrogen, are incorporated in the Airex method in PVC and in the UCC method in PE melts under a pressure of approximately 200 bar in extruders with accumulators. Subsequently, the molding compound is foamed freely (Airex method) or in a mold (UCC method).

A further foaming method that can be used is the MuCell® microcellular foam injection-molding method, which is distinguished by high productivity and an improvement in quality. The method uses supercritical fluids (SCF) of inert gases, typically nitrogen or carbon dioxide, to form uniformly distributed and equal-sized cells throughout the entire polymer material. This method is suitable for injection-molding methods, but also for extrusion methods and blow-molding methods.

Many modules comprise various components (for example housings, chips and/or passive components), which are loaded on a small substrate or a printed circuit board. For such applications, spraying methods are suitable for obtaining protection over a surface area. In the case of spraying methods, spray guns are used for example, sucking the liquid plastic in from a container and spraying it in a finely distributed form (mist) by means of a stream of compressed air. A modification of the spraying method is used for producing PU foams and elastomers, in which the corresponding raw materials are vapor-deposited onto the surfaces to be coated, usually under the mixing pressure but also under air pressure.

Furthermore, as already mentioned, a customary injection-molding method may be used for producing the housing, or else the housing is produced by extrusion.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

### LIST OF DESIGNATIONS

1 electronic component
2 carrier
3 semiconductor chip
4 leads
5 housing
6 foamed material

What is claimed:

1. In combination,
an electronic component for radio frequency applications mounted on a carrier, and
a housing encapsulating the electronic component for protection, wherein the housing comprises a foamed material.

2. The combination of claim 1, wherein the foamed material comprises a plastic material.

3. The combination of claim 1, wherein the foamed material comprises an elastomer.

4. The combination of claim 1, wherein the electronic component is a discrete element.

5. The combination of claim 1, wherein the electronic component is a semiconductor component.

6. The combination of claim 1, wherein the foamed material comprises a thermoplastic material.

7. The combination of claim 1, wherein the foamed material is a rigid or rigid-elastic foam comprising polystyrene (PS), polyurethane (PU), or polyvinyl chloride (PVC).

8. The combination of claim 1, wherein the foamed material is a soft or soft-elastic foam comprising polyurethane (PU), polyvinyl chloride (PVC), or polyethylene (PE).

9. The combination of claim 1, wherein the foamed material contains metallic particles that increase thermal conductivity and thermal capacity.

10. The combination of claim 1, wherein the electronic component is bonded to the carrier by leads.

11. A method for producing an electronic component for radio frequency applications, comprising:
(a) providing the electronic component on a carrier; and
(b) encapsulating the electronic component with a housing comprising a foamed material formed by a foaming process.

12. The method of claim 11, wherein a thermoplastic material is foamed in the foaming process.

13. The method of claim 11, wherein a rigid or rigid-elastic foam comprising polystyrene (PS), polyurethane (PU), or polyvinyl chloride (PVC) is used in the foaming process.

14. The method of claim 11, wherein a soft or soft-elastic foam comprising polyurethane (PU), polyvinyl chloride (PVC), or polyethylene (PE) is used in the foaming process.

15. The method of claim 11, wherein the housing is produced from a foamed plastic material.

16. The method of 15, wherein (b) includes encapsulating a semiconductor chip or a semiconductor module.

17. The method of claim 11, wherein the housing is produced by a spraying method, by an injection-molding method, or by extrusion.

18. The method of claim 11, further comprising adding metallic particles to the foamed material to increase the thermal conductivity and thermal capacity of the foamed material.
